(19) United States
(12) Patent Application Publication
(10) Pub. No.: US 2026/0160708 A1
(43) Pub. Date: Jun. 11, 2026

(54) SYSTEM, METHOD & APPARATUS FOR REMOTE PIPE INSPECTION

(71) Applicant: Northeast Gas Association, Parsippany, NJ (US)

(72) Inventors: Lee Carlson, Broomfield, CO (US); Jeffrey Shasho, Brooklyn, NY (US); Nishant Kumar, Bergenfield, NJ (US); Jason Herman, East Northport, NY (US)

(21) Appl. No.: 19/389,174

(22) Filed: Nov. 14, 2025

Related U.S. Application Data
(63) Continuation of application No. 16/258,594, filed on Jan. 26, 2019, now abandoned.
(63) Continuation of application No. 18/432,277, filed on Feb. 5, 2024, now abandoned.
Application No. 18/432,277 is a continuation of application No. 17/747,130, filed on May 18, 2022, now abandoned.
Application No. 17/747,130 is a continuation of application No. 16/740,605, filed on Jan. 13, 2020, now abandoned.

(51) Int. Cl. G01N 21/954; B60B 19/00; F16L 55/26

(52) U.S. Cl. CPC G01N 21/954; B60B 19/003; B60B 19/006; F16L 55/26; B60B 2900/551; B60Y 2200/40

(57) ABSTRACT

The present invention relates generally to the inspection of pipes, and the like, and more particularly to the remote inspection of ferromagnetic pipes. The invention teaches apparatus comprising, in combination: a vehicle equipped with a plurality of wheels capable of propelling the vehicle within a predetermined ferromagnetic environment to be inspected; means for remotely applying drive forces to said wheels; said wheels including a plurality of passive non-driven rollers; said passive rollers including magnetized means; means for acquiring visual images of the condition of said pipes; and means for remotely accessing said visual images; thereby enabling remote inspection of said pipes. An immediate environment in which the use of the present invention is contemplated is in inspection of ferromagnetic pipes which are located above and/or below ground.

### BACKGROUND OF THE INVENTION

The present invention relates generally to the inspection of pipes, and the like, and more particularly to the remote inspection of ferromagnetic pipes. This invention teaches a self-propelling vehicle capable of use in any number of environments. A more immediate environment in which the present invention is contemplated is in inspection of ferromagnetic pipes which are located above and/or below ground. The vehicle or robot provided by the present invention is capable of being introduced through vents in pipe configurations. Other environments include, without limitation, aircraft carrier structure, trucks, nuclear apparatus and facilities, hazardous environments, smuggling areas, structural member (e.g. I-beams, etc.) weld and other inspection, acoustics, earthquake scenarios, security, outer space, police equipment, toys, and others incorporating ferromagnetic elements.

The current state of the art of pipe inspection includes systems which require the excavation and removal of casing seals to access the carrier pipe. Problems associated with the current state of the art include undesirable costs in time and labor, as well as the ever-present risk of pipe damage from excavation and digging equipment and apparatus. There is an unfulfilled need for a system of remote inspection of ferromagnetic pipes, and the like, which does not require excavation, which is simple to operate, and which deploys efficiently and rapidly, as required. As will be appreciated from a reading of this application, the present invention overcomes the disadvantages associated with the current state of the art and satisfies this previously unfulfilled need.

### SUMMARY OF THE INVENTION

A method of enabling inspection of ferromagnetic pipes, comprising, in combination: providing a vehicle equipped with a plurality of wheels for propelling the vehicle within a predetermined ferromagnetic environment; applying propelling forces to said wheels from a remote driving location; wherein said wheels include a plurality of rollers which are relatively passive and independent with respect to said driving forces; wherein said passive rollers include magnetized means; acquiring visual information relating to the condition of such pipes; providing visual feedback of said acquired visual information to said remote driving location; and thereby facilitating a person's inspection of said pipe condition at said driving location.

Also, apparatus for inspecting ferromagnetic pipes from a remote driving location, comprising, in combination: a vehicle equipped with a plurality of wheels capable of propelling the vehicle within a predetermined ferromagnetic environment to be inspected; means for applying drive forces to said wheels from said remote location; said wheels including a plurality of passive non-driven rollers which are relatively passive and independent of said drive forces; wherein said passive rollers include magnetized means; means for acquiring visual images of the condition of said pipes; means for transmitting said visual images to said remote driving location; and thereby enabling a person's inspection of said pipes at said remote driving location.

### BRIEF DESCRIPTION OF DRAWINGS

FIG. 1 is an illustration of a self-propelling vehicle incorporating features according to the present invention;

FIG. 2 is an illustration of a vehicle of the type shown in FIG. 1, within a remote pipe elbow, shown with a red encircled portion of a wheel meant to draw attention to preferred diameters of such wheels;

FIG. 3 is a sketch illustrating a typical cased pipe section with its associated casing vent pipes;

FIG. 4 is a sketch illustrating another typical cased pipe section, showing grade;

FIG. 5 is a schematic representation of a Mecanum driven vehicle, including pictorial representations of force vectors associated with the application of wheel actuation forces to the respective wheels;

FIG. 6 is a table, associated with FIG. 3, illustrating how desired directions of movements can be achieved by the application of wheel actuation forces identified within this table;

FIG. 7 is a schematic illustration of a Mecanum wheel;

FIG. 8 is a another more realistic depiction of a Mecanum wheel;

FIG. 9 is a photographic depiction of a Mecanum wheel utilized according to the present invention;

FIG. 10 illustrates by photographs Mecanum wheels incorporating rubber coated rollers according to the present invention;

FIG. 11 is another illustration of a vehicle according to the present invention;

FIG. 12 illustrates a prior art robotic in-line inspection system to which the name “Tigre MFL System” has been coined;

FIG. 13 illustrates a prior art pneumatic bladder system in which air bladders are sequentially inflated and deflated, for use in the trenchless industry;

FIG. 14 is a sectional view of a cased pipe mock-up, which illustrates the confines and environment in which the present invention is capable of use;

FIG. 15 is a view of a vehicle according to the present invention, wherein its capability of “barrel rolling” within pipes in response to steering forces is presented;

FIG. 16 is a view of the vehicle of FIG. 15 “barrel rolling” within a vent pipe;

FIG. 17 illustrates compression fitting entry points through which the vehicle according to the present invention is capable of passing;

FIG. 18 is a side elevation view of a Mecanum wheel of the type utilized in the present invention;

FIG. 19 is another side elevation view of a Mecanum wheel of the type utilized in the present invention;

FIG. 20 pictorially illustrates in a three-dimension view a vehicle according to the present invention, and further illustrates the field of view of a camera attached to the vehicle;

FIG. 21 pictorially illustrates three side elevation views of a vehicle according to the present invention, further illustrating higher, level, and lower fields of view of a camera carried by the vehicle and manipulated remotely; and

FIG. 22 pictorially illustrates in a three-dimension view a vehicle of the type shown in FIGS. 20 and 21, wherein the vehicle is equipped with front and rear cameras.

### DETAILED DESCRIPTION OF THE INVENTION

### Discussion

The present invention overcomes the drawbacks and disadvantages of prior art attempts to solve problems by providing both apparatus and methods for inspection of ferromagnetic pipes from a remote location. Such prior art approaches involve excavation and removal of casing seals to access a carrier pipe. This drives up costs (i.e., labor) due to the time required as well as increased risk of pipe damage from digging machinery. There has been a long felt need for a flexible, rugged solution that eliminates the need for excavation, is simple to operate, and deploys rapidly is necessary.

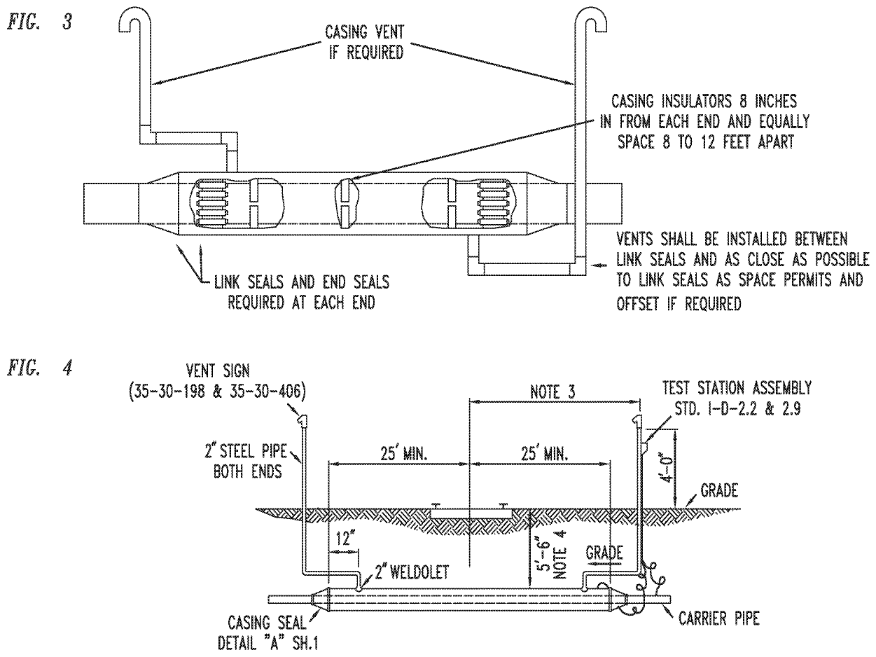

Typical vented cased piping construction, such as that used in natural gas distribution lines, are illustrated in FIGS. 3 and 4 of the drawings. There is a natural gas carrier pipe surrounded and covered by cased pipe with approximately two inches of annular radial space between the two. Vents are located on either side of a cased section and provide an easy access point from above ground (i.e., no excavation required) that may be utilized with the present invention to enter the cased pipe annular space. Casing insulators, such as is shown in FIG. 3, are typically used to maintain spacing and isolation between the two pipes. Known prior art includes U.S. Pat. No. 3,876,255, published U.S. patent application Publication No. 20120103705, and ULC Robotics Magnetic Robot for NDT Inspection disclosed at the following Website: http: //www.ulcrobotics.com/products/mag-crawler.

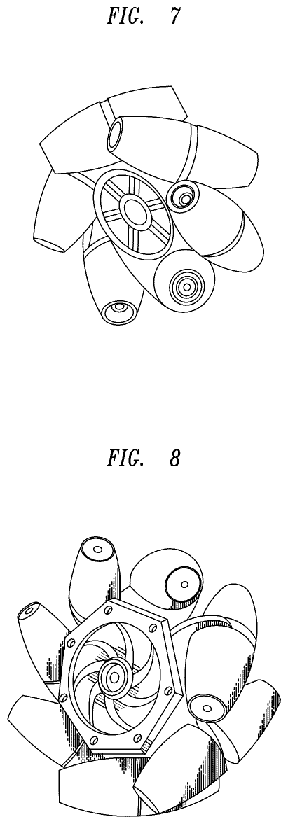

Among the disadvantages of prior art attempts to solve conventional problems are the following:
(a) Ordinary Mecanum wheels (FIGS. 7, 8), not those according to the present invention, do not possess the ability to self-attract, affix to or traverse ferromagnetic surfaces irrespective of the effects of gravity or reduction in wheel/surface traction or friction.
(b) Ordinary wheels (FIGS. 7, 8) combined with magnetic forces, not those according to the present invention, do not allow for omnidirectional motion and therefore the favorable mobility and obstacle avoidance features of the present invention are not provided.

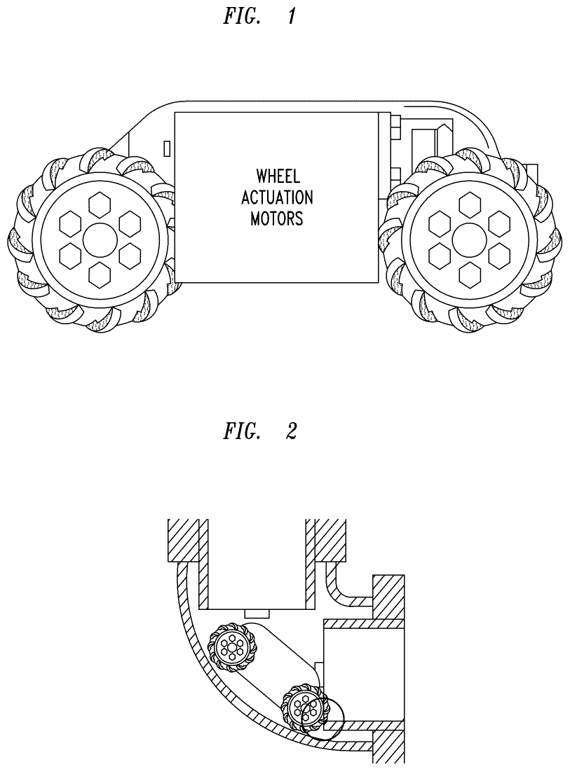

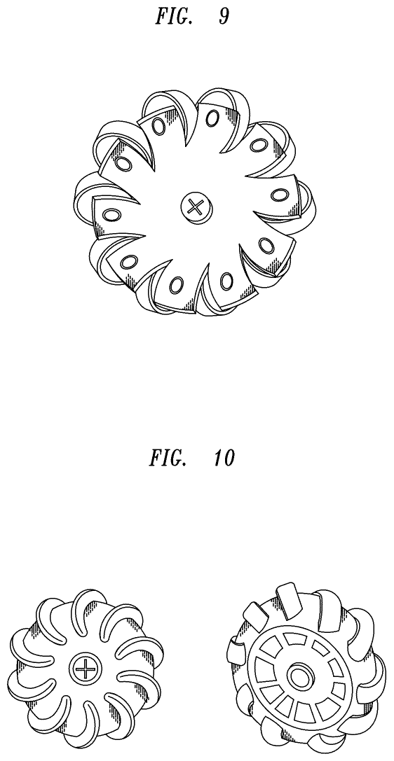

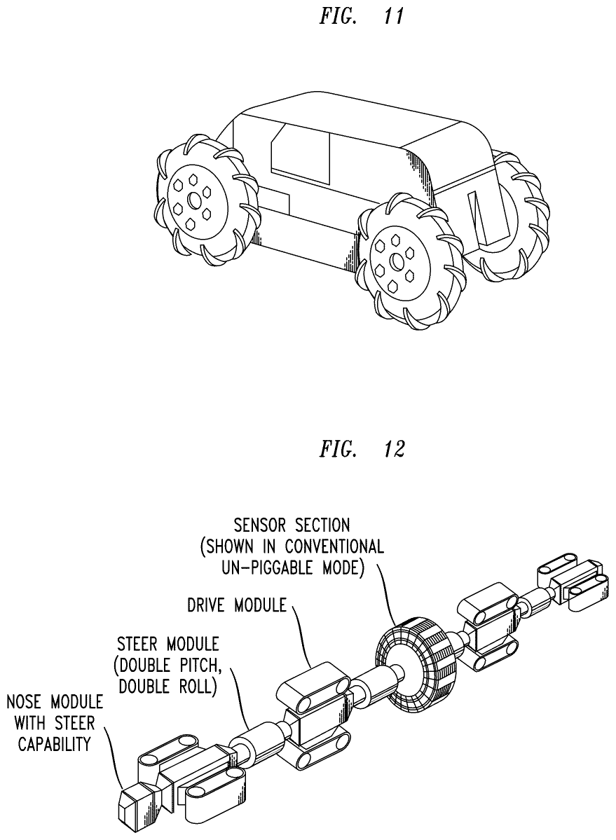

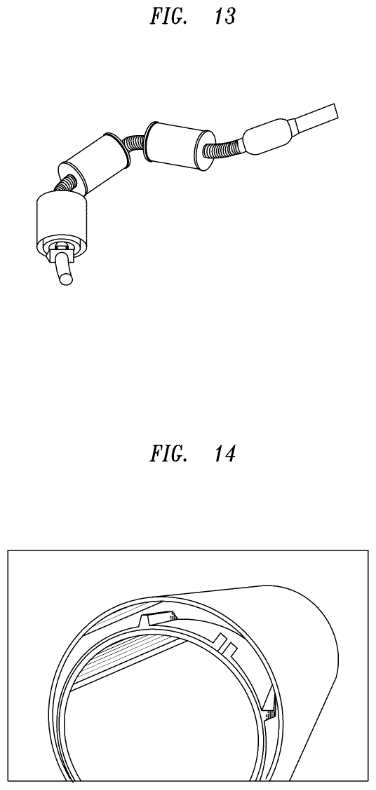

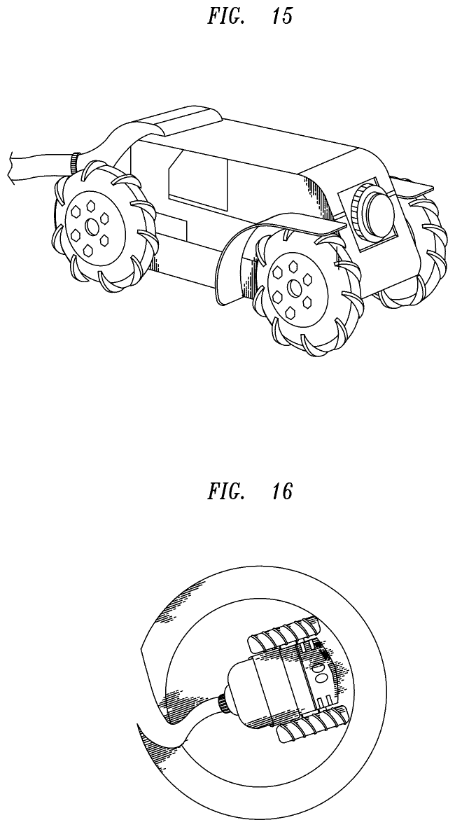

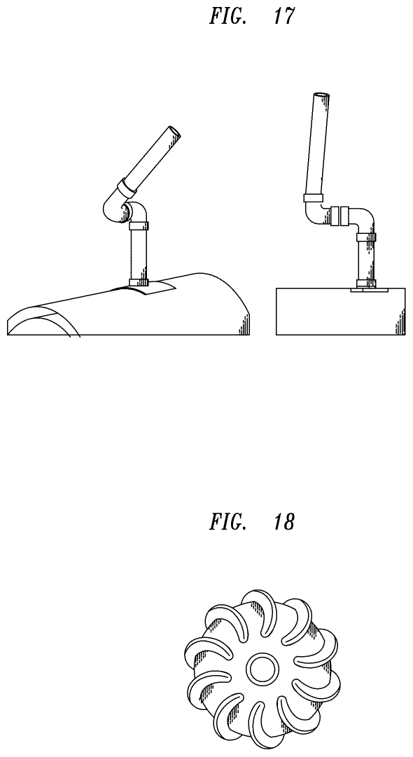

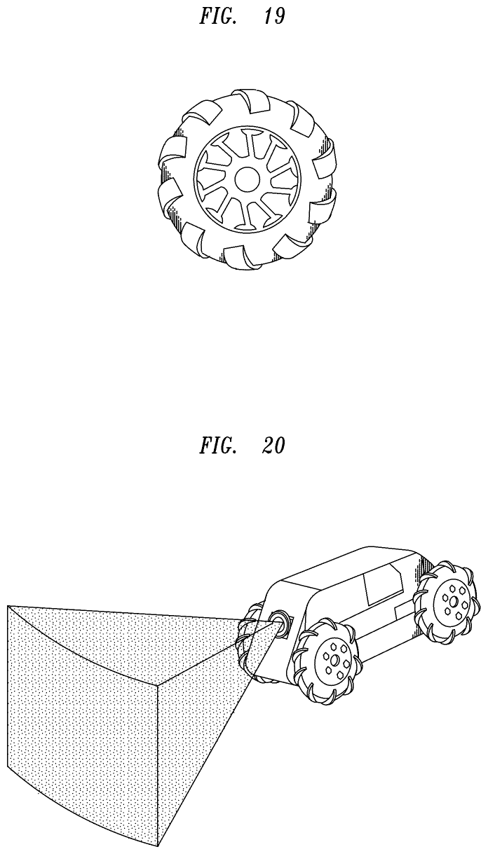

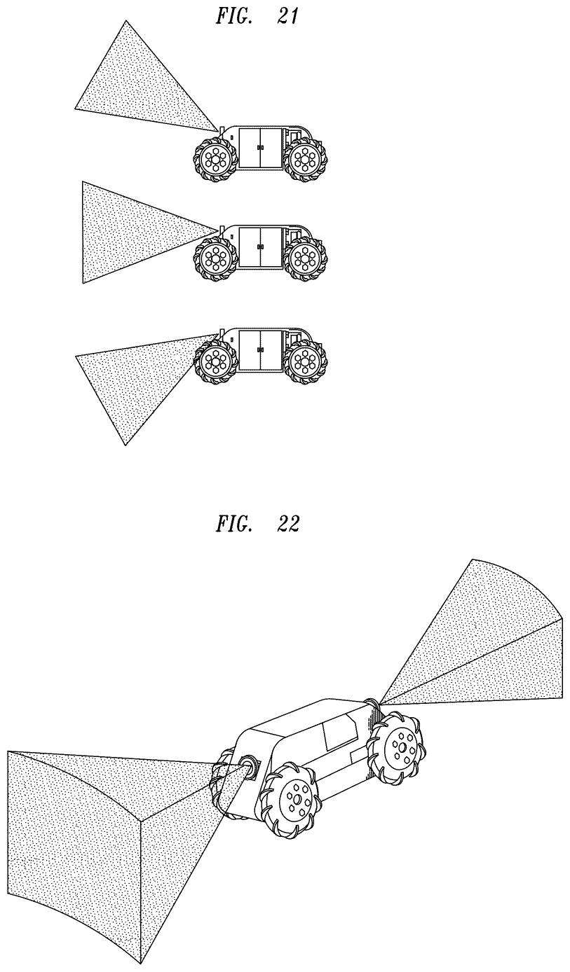

In general terms, this invention provides a vehicle for inspecting ferromagnetic pipes from a remote driving location, comprising, in combination, a vehicle (FIGS. 1, 2, 5, 15, 20, 21, 22) equipped with a plurality of relatively larger wheels (FIGS. 1, 2, 5, 9, 10, 11, 15, 18, 19) capable of propelling the vehicle within a predetermined ferromagnetic environment to be inspected (FIG. 14), means for independently applying drive forces to one or more of said wheels from said remote location, wheels including a plurality of passive non-driven rollers (FIGS. 1, 9, 10, 11, 15, 18, 19) which are either magnetized or magnetizable, means such as one or more cameras (FIGS. 20, 21, 22) for acquiring visual images of the condition of said pipes, and tethered electrical (FIG. 16) or wireless means for transmitting said visual images to said remote driving location, thereby enabling a person's inspection of said pipes at said remote driving location. In one preferred embodiment of the present invention, the passive rollers include a relatively thin coating of rubber (FIG. 10) or other frictional material applied over the magnetized elements to maximize traction or friction for improved locomotion and climbing.

This invention contemplates both novel apparatus and novel methods for accomplishing the remote inspection of ferromagnetic pipes and other ferromagnetic sites, without departing from the scope and spirit of the present invention.

As stated and suggested, implementation of the present invention enables inspection of ferromagnetic pipes which are disposed above and/or below ground.

This permits the avoidance of obstacles not navigable by currently available technology. The invention provides a system wherein configuration is possible enable omnidirectional navigation on a ferromagnetic pipe interior or exterior walls, thereby providing greater mobility options and obstacle avoidance methods. Four magnetic Mecanum wheels equipped with magnetized passive rollers provide the benefit of driving on the “ceiling” or “side” of the pipe in order to avoid debris, and permits transition from one position to the next in a relatively simple manner. Mecanum wheels equipped with magnetized rollers allow interior pipe navigation because they allow the vehicle to travel parallel to the pipes centerline, facilitating the ability to simply roll sideways up the pipe walls and inner pipe ceiling while traversing along the pipe run.

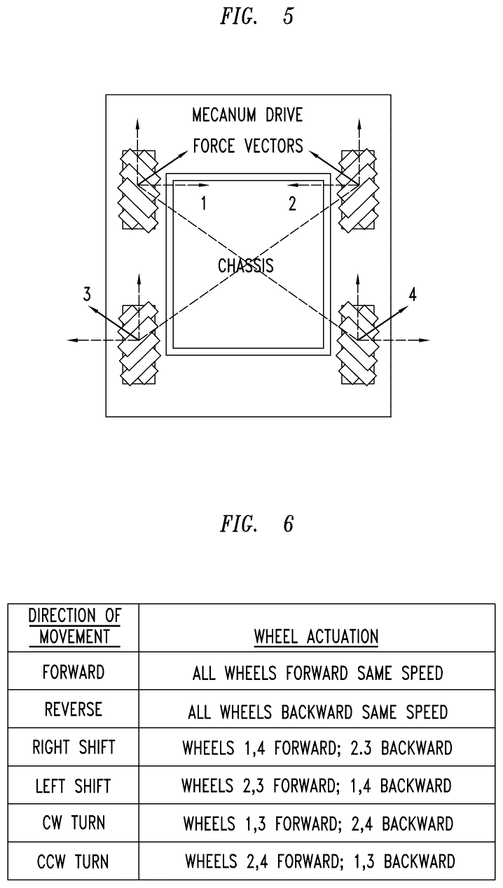

The vehicle or robot is comprised of four independently driven Mecanum wheels, each including a series of passive rollers spaced about an area at its circumference. These rollers have an axis of rotation at an offset angle from the plane of the wheel. The produces a reaction force generated by the wheel when it is driven that is at an angle to the axis of the axle (as opposed to 90° in a typical wheel). By the user's driving each wheel independently (FIGS. 5, 6) the resultant vector can be pointed in any direction, and at least three degrees of freedom are enabled during locomotion. Additionally, a moment can be generated to rotate the vehicle. Neodymium (Nd) modified cylindrical magnetic rollers are utilized as part of the Mecanum wheels and facilitate an ability to traverse and navigate ferromagnetic surfaces such as the pipes to be inspected according to the present invention. The use of Neodymium provides the invention with relatively powerful permanent magnets.

The present invention provides feedback from the vehicle or robot to a drive location by means of either wireless communications or a tether, which provides power and communications to the pipe inspection robot. It is within the scope of this invention to provide a hybrid approach, wherein wireless communication and wired tethering are used. This invention enables the user to avoid sediment and/or liquids which may sit on the bottom of pipes. It furthermore permits “driving” of the vehicle or robot along a pipe in any orientation with respect to the pipe orientation, and a gravity vector is what provides the benefit of avoiding such sediment and/or liquids. The invention permits navigation of elbows with relative ease, as well as other mobility and obstacle avoidance tasks that would otherwise be impossible or which might require complex mechanisms.

Non-magnetic guards (e.g. wheel fenders) or shields are provided control the direction and magnitude of the magnetic forces in desired directions, and furthermore prevent unwanted magnetic attraction during locomotion. The vehicle or robot may be fitted with one or more cameras to be used as a navigation aid as well as for visual inspection of pipe surfaces. Multiple cameras provide that much more feedback information. These cameras can be articulated to provide better views for inspection. Additional sensors, such as accelerometers, are contemplated to be incorporated to aid in both navigation and mapping of a pipe interior. With a known starting point and motor data, the present invention makes it possible to generate a coordinate mesh or 3D map for improved documenting of piped systems.

The present invention is broad enough in scope to contemplate use of electromagnet versus permanent magnet roller materials, to provide additional control over the magnetic forces utilized.

The examples and embodiments of the present invention included in this specification are but examples of the invention and should not be used to limit or depart from the scope and spirit of the invention.

1. A method of enabling inspection of ferromagnetic pipes, comprising, in combination:
providing a vehicle equipped with a plurality of wheels for propelling the vehicle within a predetermined ferromagnetic environment;
applying propelling forces to said wheels from a remote driving location;
wherein said wheels include a plurality of rollers which are relatively passive and independent with respect to said driving forces;
wherein said passive rollers include magnetized means;
acquiring visual information relating to the condition of such pipes;
providing visual feedback of said acquired visual information to said remote driving location; and
thereby facilitating a person's inspection of said pipe condition at said driving location.

2. Apparatus for inspecting ferromagnetic pipes from a remote driving location, comprising, in combination:
a vehicle equipped with a plurality of wheels capable of propelling the vehicle within a predetermined ferromagnetic environment to be inspected;
means for applying drive forces to said wheels from said remote location;
said wheels including a plurality of passive non-driven rollers which are relatively passive and independent of said drive forces;
wherein said passive rollers include magnetized means;
means for acquiring visual images of the condition of said pipes;
means for transmitting said visual images to said remote driving location; and
thereby enabling a person's inspection of said pipes at said remote driving location.
